(19) United States
(12) Patent Application Publication
(10) Pub. No.: US 2018/0115225 A1
(43) Pub. Date: Apr. 26, 2018

(54) CIRCUIT INTEGRATED MOTOR

(71) Applicants: Shinichi Togawa, Aichi (JP); Takenobu Nakamura, Gifu (JP); Yoji Mori, Aichi (JP); Hiroyuki Ohnishi, Aichi (JP)

(72) Inventors: Shinichi Togawa, Aichi (JP); Takenobu Nakamura, Gifu (JP); Yoji Mori, Aichi (JP); Hiroyuki Ohnishi, Aichi (JP)

(73) Assignee: OMRON AUTOMOTIVE ELECTRONICS CO., LTD., Aichi (JP)

(21) Appl. No.: 15/792,205

(22) Filed: Oct. 24, 2017

(30) Foreign Application Priority Data
Oct. 25, 2016 (JP) 2016-208553

(51) Int. Cl. H02K 11/33; H02K 9/00; H02K 11/00; B62D 5/04

(52) U.S. Cl. CPC H02K 11/33; B62D 5/0463; H02K 11/0094; H02K 9/00

(57) ABSTRACT

A circuit integrated motor includes: a motor accommodated in a motor housing; a heat sink adjacent to the motor housing in an axis axial direction; a substrate arranged in at least one of the heat sink and the motor housing; and a module mounted on the substrate, and in which a drive circuit for driving that drives the motor is housed. The module has a substantially rectangular cuboid including a bottom surface facing the substrate, and two opposing main side surfaces perpendicular to the bottom surface and having areas larger than an area of the bottom surface. The heat sink includes an insertion portion into which the module is inserted. An inner surface of the insertion unit portion is in direct or indirect contact with at least the two main side surfaces.

### CROSS-REFERENCES TO RELATED APPLICATIONS

This application is based upon and claims the benefit of priority from Japanese Patent Application No. 2016-208553 filed on Oct. 25, 2016, the entire contents of which are incorporated herein by reference.

### FIELD

One or more embodiments of the present invention relate to a circuit integrated motor provided integrally with a circuit.

### BACKGROUND

In the related art, a technology for efficiently performing heat dissipation is known in a circuit integrated motor that is provided integrally with a motor used for electric power steering mounted in a vehicle and a circuit for controlling the motor. For example, JP-A-2016-054585 discloses an electric power steering device in which a size of a housing housed in an electronic control device is suppressed to be increased in the radial direction and heat is efficiently dissipated to the outside. In this electric power steering device, the heat can be efficiently dissipated to the housing at the outside by disposing a metal substrate of a power supply circuit unit and a metal substrate of the power conversion unit on both surfaces of an intermediate tube unit having a heat dissipation substrate therein.

In addition, JP-A-2015-134598 discloses a motor drive device that realizes a small-sized compact structure, in which a motor case and a control unit case are connected integrally with each other in a direction along the rotation shaft of the motor. This motor drive device includes a heat sink made by metal die casting, as a part of the control unit case. A power module surface having an FET bridge circuit or the like is attached to a flat plate portion extending in the vertical direction of a motor rotation shaft of the heat sink via a heat conduction member. In addition, the heat is transferred to the heat sink using a heat dissipation plate and a screw on the back surface of the power module.

### SUMMARY

One or more embodiments of the invention provide a circuit integrated motor that can be downsized both in the radial direction and the axial direction, while improving heat dissipation and further facilitating an easy assembly.

According to one or more embodiments of the invention, a circuit integrated motor includes: a motor that includes a rotation shaft and is accommodated in a motor housing; a heat sink that is arranged to be adjacent to the motor housing in an axial direction of the rotation shaft and is connected to the motor housing; a lid that is arranged on an opposite side of the motor housing with the heat sink interposed therebetween in the axial direction of the rotation shaft; a substrate that is arranged in at least one of the heat sink and the motor housing; and a module that is mounted on the substrate, and in which a drive circuit that drives the motor is housed. The module has a substantially rectangular cuboid including a bottom surface facing the substrate, and two opposing main side surfaces perpendicular to the bottom surface and having areas larger than an area of the bottom surface. The heat sink includes an insertion portion into which the module is inserted, and an inner surface of the insertion portion is in directly or indirect contact with at least the two main side surfaces.

According to this configuration, it is possible to provide a circuit integrated motor, in which the size in the radial direction can be reduced since the module has a main side surface with a large area in the axial direction, and in addition, the downsizing in the axial direction can be achieved since the heat sink includes the insertion portion into which the module elongated in the axial direction is inserted, and thus, the heat generated by the module can be efficiently dissipated.

Furthermore, the heat sink may include an outer circumferential portion in a circumferential direction of the rotation shaft, and the outer circumferential portion may be connected to the motor housing.

According to this configuration, by connecting the outer circumferential portion of the heat sink to the motor housing, the heat generated by the module can be efficiently dissipated to the motor housing having a large surface area.

Furthermore, the drive circuit may include a first module and a second module independent from each other for redundancy, and the insertion portion may include a first insertion portion into which the first module is inserted and a second insertion portion into which the second module is inserted.

According to this configuration, even in a case where the module is made redundant in order to improve the reliability, it is possible to share the components by providing two insertion portions.

Furthermore, the lid may include a connector terminal extending in the axial direction of the rotation shaft, the heat sink may have a through-hole through which the connector terminal passes in the axial direction of the rotation shaft, and the connector terminal passing through the through-hole may be connected to the substrate.

According to this configuration, since the assembly of the lid and the substrate can be performed by being inserted in the axial direction of the rotation shaft via the heat sink, the assembly of the circuit integrated motor can easily be performed.

Furthermore, the motor may include a first terminal group including a plurality of terminals extending toward the substrate, the substrate may include a second terminal group including a plurality of terminals connected to the first terminal group, and the motor housing may have a terminal connection opening in the vicinity of the first terminal group and the second terminal group.

According to this configuration, since the assembly of the substrate and the motor is performed by being inserted in the axial direction of the rotation shaft, the assembly of the circuit integrated motor can easily be performed.

Furthermore, in a case where the inner surface of the insertion portion is in indirect contact with the main side surface, an inner surface of the insertion portion and the main side surface may be in contact with each other via the filler for heat dissipation.

According to this configuration, it is possible to provide a heat sink of which the thermal conductivity is easily improved even without improving the assembly accuracy of the module and the molding accuracy of the insertion portion.

According to one or more embodiments of the invention, it is possible to provide a circuit integrated motor that can be downsized both in the radial direction and the axial direction, while improving heat dissipation and further facilitating an easy assembly.

### BRIEF DESCRIPTION OF THE DRAWINGS

FIG. 1A is a top view of a circuit integrated motor in a first embodiment of the invention;

FIG. 1B is a perspective view of the circuit integrated motor in the first embodiment of the invention;

FIG. 1C is a sectional view of the circuit integrated motor in the first embodiment of the invention taken along the line A-A;

FIG. 2 is an exploded perspective view of the circuit integrated motor in the first embodiment of the invention;

FIG. 3A is a top view of a heat sink of the circuit integrated motor in the first embodiment of the invention;

FIG. 3B is a front view of the heat sink of the circuit integrated motor in the first embodiment of the invention;

FIG. 3C is a side view of the heat sink of the circuit integrated motor in the first embodiment of the invention;

FIG. 4A is a top view of a lid of the circuit integrated motor in the first embodiment of the invention;

FIG. 4B is a front view of the lid of the circuit integrated motor in the first embodiment of the invention;

FIG. 4C is a side view of the lid of the circuit integrated motor in the first embodiment of the invention;

FIG. 5A is a top view of a substrate of the circuit integrated motor in the first embodiment of the invention;

FIG. 5B is a front view of the substrate of the circuit integrated motor in the first embodiment of the invention;

FIG. 5C is a side view of the substrate of the circuit integrated motor in the first embodiment of the invention;

FIG. 5D is a bottom view of the substrate of the circuit integrated motor in the first embodiment of the invention;

FIG. 5E is a perspective view from obliquely above of the substrate of the circuit integrated motor in the first embodiment of the invention;

FIG. 5F is a perspective view from obliquely below of the substrate of the circuit integrated motor in the first embodiment of the invention;

FIG. 6A is a perspective view of a module of the circuit integrated motor in the first embodiment of the invention;

FIG. 6B is a side view of the module of the circuit integrated motor in the first embodiment of the invention;

FIG. 6C is a perspective view of a module of the circuit integrated motor in a modification example of the first embodiment of the invention;

FIG. 6D is a side view of the module of the circuit integrated motor in the modification example of the first embodiment of the invention;

FIG. 7A is a sectional view of a combination of the heat sink and the substrate of the circuit integrated motor in the first embodiment of the invention taken along the line B-B in FIG. 5A;

FIG. 7B is a perspective view from obliquely above of the combination of the heat sink and the substrate of the circuit integrated motor in the first embodiment of the invention;

FIG. 7C is a perspective view from obliquely below of the combination of the heat sink and the substrate of the circuit integrated motor in the first embodiment of the invention;

FIG. 7D is a perspective view from below of only the heat sink of the circuit integrated motor in the first embodiment of the invention;

FIG. 8 is a block diagram of the module of the circuit integrated motor in the first embodiment of the invention; and

FIG. 9 is a redundant block diagram of a redundant module of the circuit integrated motor in the first embodiment of the invention.

### DETAILED DESCRIPTION

In embodiments of the invention, numerous specific details are set forth in order to provide a thorough understanding of the invention. However, it will be apparent to one of ordinary skill in the art that the invention may be practiced without these specific details. In other instances, well-known features have not been described in detail to avoid obscuring the invention.

### First Embodiment

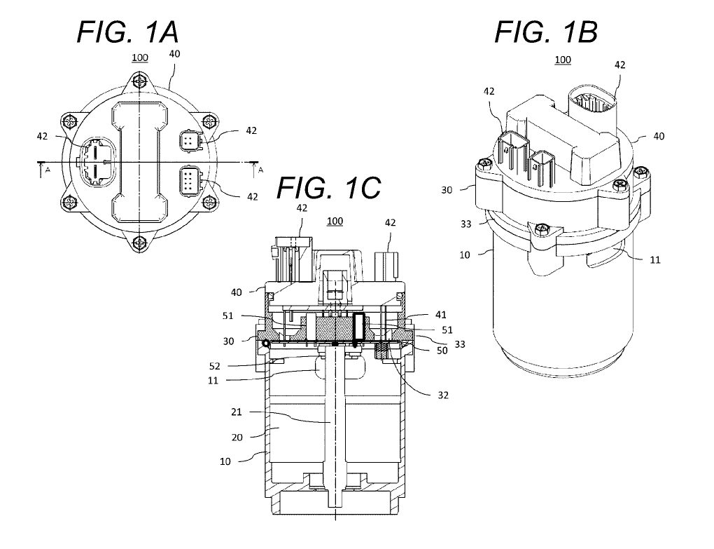

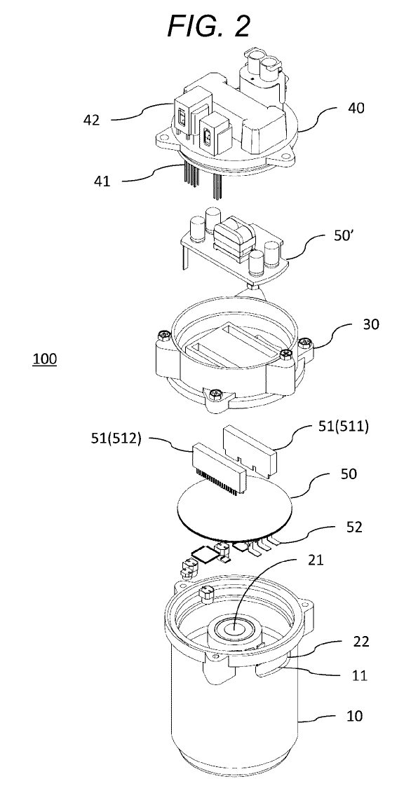

A circuit integrated motor 100 in the present embodiment will be described with reference to FIG. 1A to FIG. 1C and FIG. 2. The circuit integrated motor 100 is used for an electric power steering control device mounted on a vehicle, and causes a steering device to generate a steering torque in order to assist the torque when rotating a steering wheel. For example, when a rotation direction and a rotation torque of a steering shaft that is rotated by a driver's rotating operation of a steering wheel are detected, the circuit integrated motor 100 causes the steering device to generate a torque for driving a motor 20 so as to rotate in the same direction as the rotation direction of the steering shaft to assist the steering. The circuit integrated motor 100 is mainly configured by integrating the motor 20 for generating a steering assist torque and a drive circuit configured with a semiconductor element or the like for controlling the rotation speed and the rotation torque of the motor 20.

The circuit integrated motor 100 includes the motor 20 having a rotation shaft 21 for outputting the rotation torque, a motor housing 10 accommodating the motor 20, a heat sink 30 connected to the motor housing 10, and a heat sink 30, a lid 40 connected to the heat sink 30, a substrate 50 arranged in at least one of the heat sink 30 and the motor housing 10, and a module 51 mounted on the substrate 50 and enclosed with a drive circuit for driving the motor 20. The motor 20 is driven by a three-phase alternating current which is advantageous for generating large torques. The motor housing 10 is made from aluminum alloy or the like to accommodate the motor 20 therein and has a cylindrical shape.

The rotation shaft 21 which becomes an output shaft of the motor 20 protrudes at one end side of the cylindrical shaped motor housing 10, and the heat sink 30 and the lid 40 are connected to the other end side. The heat sink 30 is arranged adjacent to the motor housing 10 in the axial direction of the rotation shaft 21, and one end side thereof is tightly connected to the motor housing 10 by screw-tightening or the like. The other end side of the heat sink 30 is connected to the lid 40. The heat sink 30 is made from a thermally conductive material such as an aluminum alloy.

The heat sink 30 includes an outer circumferential portion 33 at a portion nearest to the motor housing 10 in the circumferential direction of the rotation shaft 21, and the outer circumferential portion 33 is connected to an upper end of the motor housing. In the configuration described above, by connecting the outer circumferential portion 33 of the heat sink 30 and the motor housing 10, the heat generated by the module 51 can be efficiently dissipated to the motor housing 10 having a large surface area.

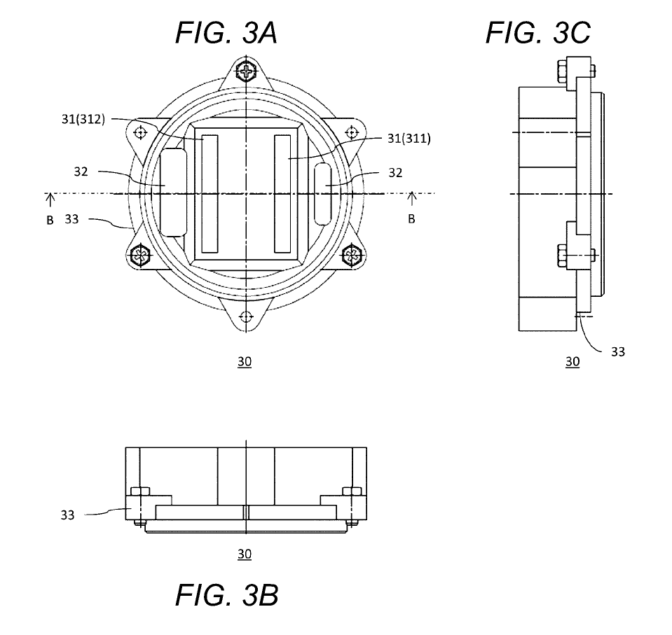

As illustrated in FIG. 3A to FIG. 3C, the heat sink 30 includes two insertion portions 31, that is, a first insertion portion 311 and a second insertion portion 312, and two through-holes 32 extending through the lid 40 and the substrate 50 on both sides. The insertion portion 31 is a hole into which the module 51 is inserted, and is a hole having almost the same shape as that of the inserted module 51 and having a same size or a size slightly larger than that of inserted module 51. The through-hole 32 is a hole through which a connector terminal 41 described later passes in the axial direction of the rotation shaft 21.

As illustrated in the sectional view in FIG. 1C, the surface of the heat sink 30 on the motor housing 10 side is almost flat except the portion of the holes. On the other hand, the surface of the heat sink 30 on the lid 40 side is raised such that the thickness of the center portion where the insertion portion 31 is positioned becomes thick, and is recessed in the vicinity of the through-holes 32. The thickness of the center portion where the insertion portion 31 is positioned is almost equal to the height of the module 51 from the surface of the substrate 50, and thus, it is easy to absorb the heat generated by the module 51 by directly or indirectly being in contact with the wide surface of the module 51.

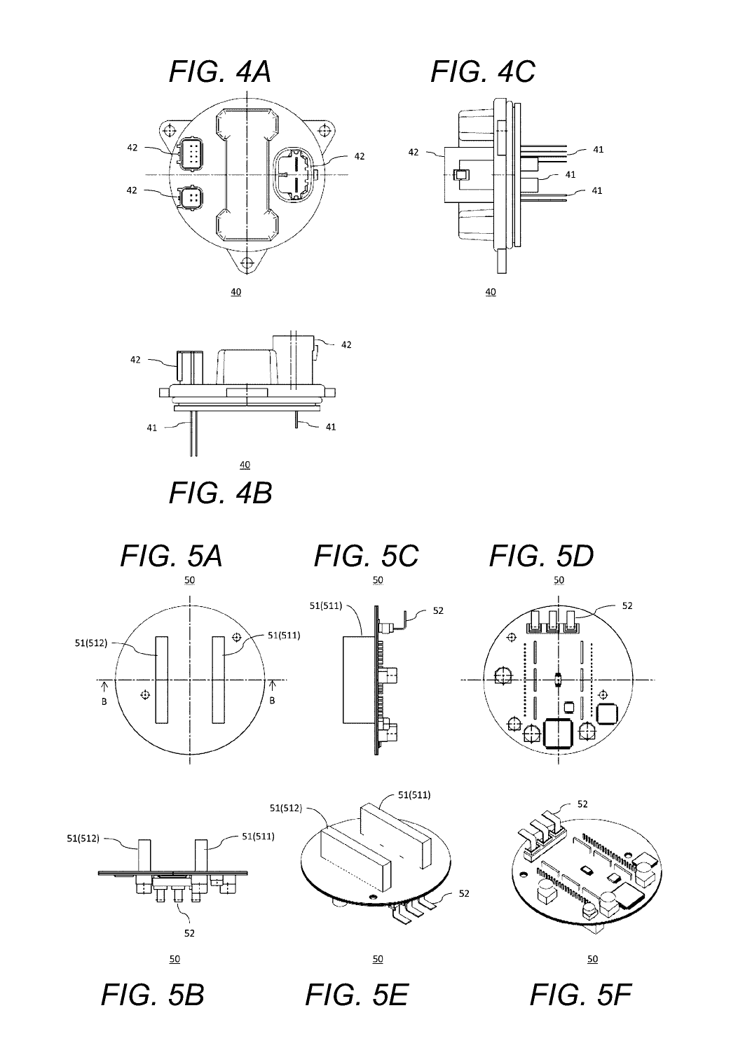

In addition, the lid 40 is arranged on the opposite side of the motor housing 10 across the heat sink 30 in the axial direction of the rotation shaft 21, and is corresponding to the top portion of the circuit integrated motor 100 if the side where the rotation shaft 21 protrudes is the bottom portion of the circuit integrated motor 100 having a cylindrical outer shape. As illustrated in FIG. 4A to FIG. 4C, the lid 40 includes a connector 42 for connecting an external power supply cable or a control cable (not illustrated) to the portion corresponding to the top portion, and a connector terminal 41 extending from the connector 42 in the axial direction of the rotation shaft 21.

The connector terminal 41 is electrically connected to the substrate 50 via the through-hole 32 of the heat sink 30, and provides the motor 20 with a power source and provides the module 51 with information signals such as a rotation torque of the steering shaft via the substrate 50. The lid 40 is tightly connected to the heat sink 30 by screw-tightening or the like.

The substrate 50 is a printed substrate arranged in the vicinity of the boundary between the cylindrical heat sink 30 and the motor housing 10, and has a surface perpendicular to the rotation shaft 21. The substrate 50 includes a module 51 on one side thereof and a group of electronic components (for example, the PWM control circuit described below) that configures a part of circuits necessary to drive the motor 20 on the other side thereof, a substrate surface that connects the module 51 and the group of electronic components to each other, and a signal line wired in the substrate. The substrate 50 is arranged inside the heat sink 30 and the motor housing 10 such that the module 51 is positioned on the heat sink 30 side. The substrate itself of the substrate 50 may be arranged closer to the lid 40 side than that in the present embodiment and all the configuration elements of the substrate 50 may be arranged in the heat sink 30.

A drive circuit for driving the motor 20 is housed in the module 51 using a ceramic or plastic cover. As described below, since the footprint of the module 51 is small and the height is high with respect to the substrate 50, the motor 20 may be housed by a single inline package (SIP). Since the module 51 is configured with semiconductor elements that control the rotation speed and rotation torque of the motor 20, the amount of heat generation is large compared to a case of the electronic components on the surface on the opposite side of the substrate 50 on which the module 51 is mounted.

The module 51 is arranged on the heat sink 30 side and the electronic components on the surface on the opposite side of the surface of the substrate 50 on which the module 51 is mounted are arranged on the motor housing 10 side. On the motor housing 10 side, a second terminal group 52 for supplying the power to the motor 20 is arranged in close proximity to and facing a first terminal group 22 of the motor 20 configured with a plurality of terminals toward the direction of the substrate 50 so as to be electrically connected to each other. In addition, in FIG. 2, there is an additional substrate 50′ between the lid 40 and the heat sink 30, however, it is not necessary if all the electronic components can be mounted on the substrate 50.

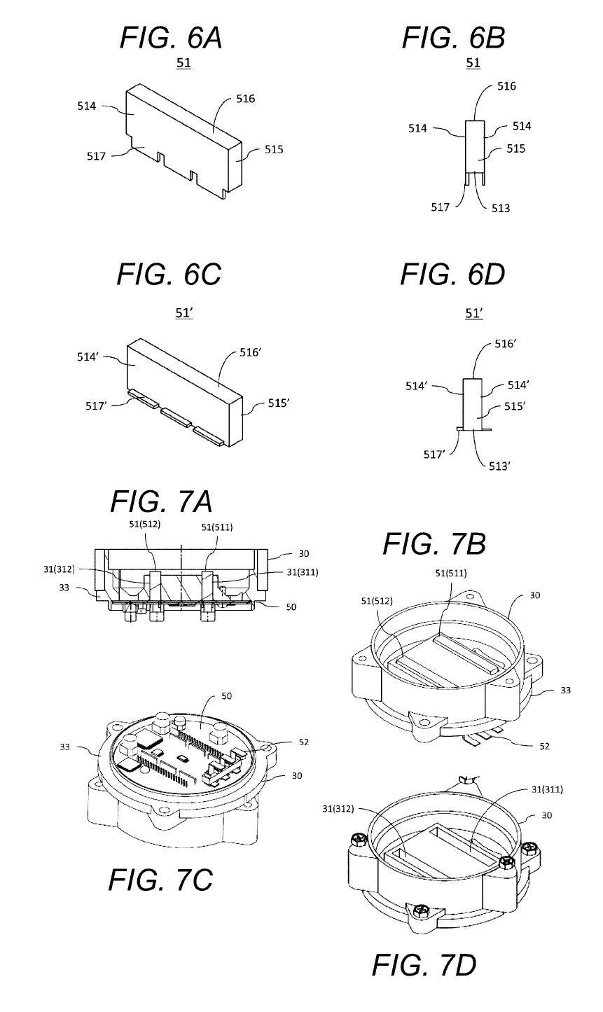

As illustrated in FIG. 6A to FIG. 6D, the module 51 has a rectangular cuboid including a bottom surface 513 and an upper surface 516, two main side surfaces 514, and two sub-side surfaces 515 of which the shape and size are equal to each other. The module 51 has a rectangular cuboid including the bottom surface 513 facing the substrate 50, the upper surface 516 parallel to the bottom surface 513 and having size and shape equal to those of the bottom surface 513, two main side surfaces 514 facing each other of which the area is larger than that of the bottom surface 513 and is orthogonal to the bottom surface 513, and two sub-side surfaces 515 of which the area is smaller than that of the main side surface 514. It is preferable that the module 51 is a so-called flat rectangular cuboid of which the surface area is large relative to the volume since the amount of heat generation is large. The main side surface 514 is a surface rising from the long side of the bottom surface 513.

In the vicinity of the boundary of the bottom surface 513 and the main side surface 514, lead wires 517 and 517′ are provided for electrically connecting the drive circuit to the substrate 50. The lead wire 517 is a type of being inserted into the through-hole formed in the substrate 50 as illustrated in FIG. 6A and FIG. 6B, and the lead wire 517′ is a type of being mounted on the surface of substrate 50 as illustrated in FIG. 6C and FIG. 6D.

As illustrated in FIG. 7A to FIG. 7D, the module 51 is inserted into the insertion portion 31 of the heat sink 30 and is in contact with the inner surface of the insertion portion 31. The thickness of the insertion portion 31 is almost equal to the height of the module 51 from the surface of the substrate 50. It is preferable that the inner surface of the insertion portion 31 of the heat sink 30 made from a thermally conductive material is formed to be almost the same shape with the size almost equal to the upper surface 516 and the bottom surface 513, and is in direct contact with the main side surface 514 and the sub-side surface 515. In addition, the inner surface of the insertion portion 31 may at least be in direct contact with the main side surface 514. In addition, even in a case of not being in direct contact with the main side surface 514 or the sub-side surface 515, the inner surface of the insertion portion 31 may be in indirectly connect with the main side surface 514 or the sub-side surface 515 via a thermally conductive filler for heat dissipation. In this way, the thermal conductivity can easily be improved even without improving the assembly accuracy of the module 51 and the molding accuracy of the insertion portion 31.

As described above, since height of the module 51 from the substrate 50 is high and footprint with respect to the substrate 50 is small, the module 51 can be downsized in the radial direction, and since the module 51 has two main side surfaces 514 having large areas in the axial direction of rotation shaft 21, and thus, the heat generated by module 51 can be efficiently dissipated. In addition, since the heat sink 30 includes the insertion portion 31 into which the module 51 elongated in the axial direction is inserted, it is possible to achieve the downsizing to suppress the extension in the axial direction. As described above, the circuit integrated motor 100 can achieve the downsizing in the radial direction and in the axial direction, it is easy to install the circuit integrated motor 100 in a direction parallel to the rack in the steering device.

In addition, as described above, the lid 40 includes the connector terminal 41 extending in the axial direction of the rotation shaft 21, the heat sink 30 includes the through-hole 32 for passing the connector terminal 41 in the axial direction of the rotation shaft 21, and the connector terminal 41 passing through the through-hole 32 is connected to the substrate 50. In this way, since the assembly of the lid 40 and the substrate 50 can be performed by being inserted in the axial direction of the rotation shaft 21 via the heat sink 30, the assembly of the circuit integrated motor 100 can easily be performed.

In addition, as described above, the motor 20 includes the first terminal group 22 configured with a plurality of terminals towards the direction of the substrate 50, the substrate 50 includes the second terminal group 52 configured with a plurality of terminals connected to the first terminal group 22, and the motor housing 10 includes the terminal connection opening 11 in the vicinity of the first terminal group 22 and the second terminal group 52. When the assembly is performed from the motor housing 10 to the lid 40, it is possible to easily connect the first terminal group 22 and the second terminal group 52 to each other which are arranged in the vicinity of each other through the terminal connection opening 11 by welding or the like. Using this configuration, since the assembly of the substrate 50 and the motor 20 can be performed by being inserted in the axial direction of the rotation shaft 21, the assembly of the circuit integrated motor 100 can easily be performed.

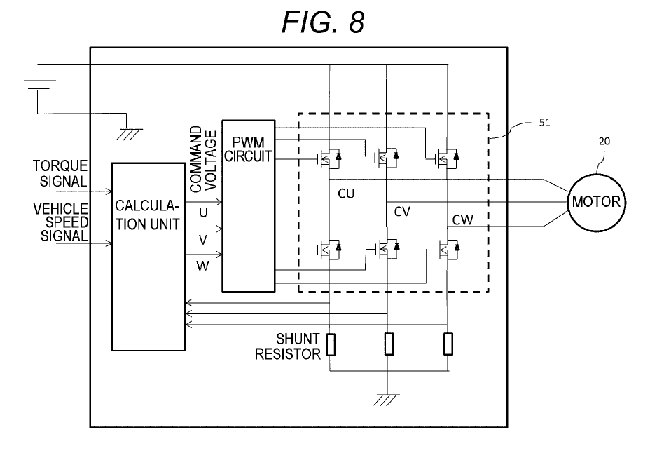

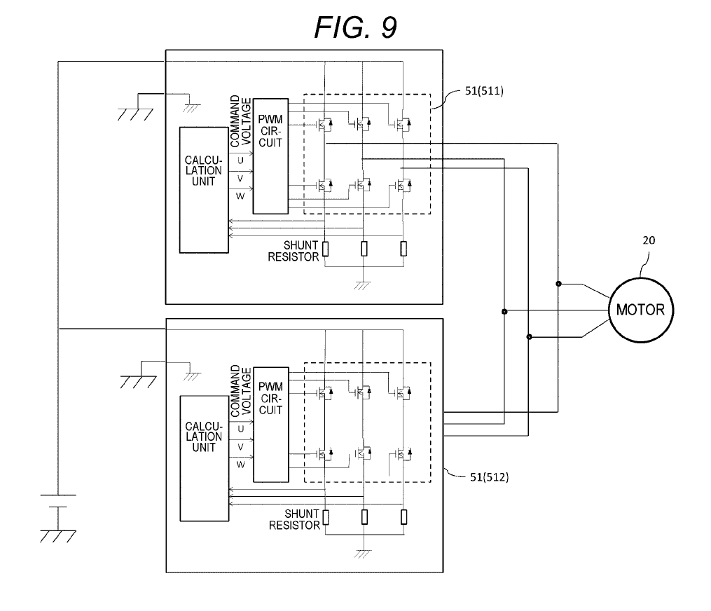

The drive circuit housed in the module 51 is a bridge circuit that is configured in such a manner that phase circuits CU, CV, and CW corresponding to each phase U, V, and W of the three-phase motor 20 illustrated in FIG. 8 are connected in parallel. The bridge circuit is a feedback circuit that receives a control from a PWM circuit that outputs a pulse width modulation (PWM) signal to each phase, and receives a control from the calculation unit as a whole.

The bridge circuit is connected to a positive electrode side of a battery via a power supply line and is grounded through a ground line. Each phase circuits CU, CV, and CW of the bridge circuit includes a high-potential side switching element provided on the power supply line side, a low potential side switching element provided on the ground line, and a shunt resistor provided at the closest to the ground line side, in series. Generally, MOSFETs (metal oxide semiconductor field effect transistors) are used as high-potential side switching elements and low-potential side switching elements.

A drain of the high-potential side switching element is connected to the power supply line. A source of the high-potential side switching element is connected to a drain of the low-potential side switching element. A source of the low-potential side switching element is connected to the ground line via a shunt resistor. A PWM signal generated by the PWM circuit is input to gates of the high-potential side switching element and the low-potential side switching element, and the state between the source and drain is switched to ON/OFF.

The shunt resistor is provided on the lower potential side (the ground side) of the low-potential side switching element, and detects the current supplied to each phase of the motor 20 from the bridge circuit. Normally, the driving power is supplied to the motor 20 by supplying a sine wave. At this time, since the calculation unit needs the feedback of the current value of each phase U/V/W, the shunt resistor is provided to detect the current of each phase in each phase circuit CU/CV/CW.

The connection points of the high-potential side switching element and the low-potential side switching element are respectively connected to the phases of motor 20. In addition, the connection points of the low-potential side switching element and the shunt resistor are respectively connected to the calculation unit such that the phase current value of each phase circuit CU/CV/CW is fed back via the AD converter (not illustrated).

The calculation unit receives the phase current value obtained from the shunt resistor, the steering torque value signal of the steering device obtained from other sensors (for example, the magneto-resolver that detects the rotation angle of the motor 20) and the electric control unit (ECU, not illustrated), the vehicle speed, the rotation angle, and the like. The calculation unit calculates a command voltage for each phase corresponding to the assist force to be applied to the steering device by the motor 20 based on the steering torque value signal given by the driver to the steering device at that vehicle speed and the phase current value detected by the shunt resistor, and then outputs the command voltage to the PWM circuit. The calculation unit is configured with a microcomputer having CPU and memory.

The PWM circuit generates a duty value based on the command voltage of each phase output from the calculation unit. The PWM circuit generates a PWM signal that drives the rotation of the motor 20 based on this duty value, and outputs the PWM signal to the high-potential side switching element and the low-potential side switching element. Each PWM signal is input to the gates of the high-potential side switching element and the low-potential side switching element, and the bridge circuit converts the battery power as a DC power supply by PWM control and supplies the result to the motor 20.

If any one of the switching elements used in these bridge circuits fails, the motor 20 cannot be controlled, and then, the electric power steering control device cannot function. Therefore, in the present embodiment, the bridge circuit, that is, the module 51 is configured to include two modules of the first module 511 and the second module 512 for the redundancy of the control mechanism, and both the drive circuits included in both modules are identical and independently drive the motor 20. As described above, even in a case where a plurality of modules 51 are mounted on the substrate 50, the height of module 51 (the first module 511 and the second module 512) is high and the footprint of the module is small with respect to the substrate 50, and thus, the module 51 can easily be mounted on the substrate 50. In addition, even in a case where the module 51 is made redundant in order to improve the reliability, by configuring the insertion portion 31 (the first insertion portion 311 and the second insertion portion 312) into which the modules are inserted, it is possible to share the components and to easily install the module 51 in a redundant manner.

The present invention is not limited to the described examples but can be implemented in a range that does not depart from the contents set forth in the claims. In other words, the invention is described with illustrations for a specific embodiment, and it will be understood by those skilled in the art that various modifications can be added to the quantity or other detail configurations in the embodiment described above without departing from the spirit and scope of the present invention.

While the invention has been described with respect to a limited number of embodiments, those skilled in the art, having benefit of this disclosure, will appreciate that other embodiments can be devised which do not depart from the scope of the invention as disclosed herein. According, the scope of the invention should be limited only by the attached claims.

1. A circuit integrated motor comprising:
a motor that comprises a rotation shaft and is accommodated in a motor housing;
a heat sink that is arranged to be adjacent to the motor housing in an axial direction of the rotation shaft and is connected to the motor housing;
a lid that is arranged on an opposite side of the motor housing with the heat sink interposed therebetween in the axial direction of the rotation shaft;
a substrate that is arranged in at least one of the heat sink and the motor housing; and
a module that is mounted on the substrate, and in which a drive circuit that drives the motor is housed,
wherein the module has a substantially rectangular cuboid comprising a bottom surface facing the substrate, and two opposing main side surfaces perpendicular to the bottom surface and having areas larger than an area of the bottom surface,
wherein the heat sink comprises an insertion portion into which the module is inserted, and
wherein an inner surface of the insertion portion is in direct or indirect contact with at least the two main side surfaces.

2. The circuit integrated motor according to claim 1,
wherein the heat sink comprises an outer circumferential portion in a circumferential direction of the rotation shaft, and the outer circumferential portion is connected to the motor housing.

3. The circuit integrated motor according to claim 1,
wherein the drive circuit comprises a first module and a second module independent from each other for redundancy, and the insertion portion comprises a first insertion portion into which the first module is inserted and a second insertion portion into which the second module is inserted.

4. The circuit integrated motor according to claim 2,
wherein the drive circuit comprises a first module and a second module independent from each other for redundancy, and the insertion portion comprises a first insertion portion into which the first module is inserted and a second insertion portion into which the second module is inserted.

5. The circuit integrated motor according to claim 1,
wherein the lid comprises a connector terminal extending in the axial direction of the rotation shaft,
wherein the heat sink has a through-hole through which the connector terminal passes in the axial direction of the rotation shaft, and
wherein the connector terminal passing through the through-hole is connected to the substrate.

6. The circuit integrated motor according to claim 2,
wherein the lid comprises a connector terminal extending in the axial direction of the rotation shaft,
wherein the heat sink has a through-hole through which the connector terminal passes in the axial direction of the rotation shaft, and
wherein the connector terminal passing through the through-hole is connected to the substrate.

7. The circuit integrated motor according to claim 1,
wherein the motor comprises a first terminal group comprising a plurality of terminals extending toward the substrate,
wherein the substrate comprises a second terminal group comprising a plurality of terminals connected to the first terminal group, and
wherein the motor housing has a terminal connection opening in the vicinity of the first terminal group and the second terminal group.

8. The circuit integrated motor according to claim 2,
wherein the motor comprises a first terminal group comprising a plurality of terminals extending toward the substrate,
wherein the substrate comprises a second terminal group comprising a plurality of terminals connected to the first terminal group, and
wherein the motor housing has a terminal connection opening in the vicinity of the first terminal group and the second terminal group.

9. The circuit integrated motor according to claim 1,
wherein an inner surface of the insertion portion and the main side surfaces are in contact with each other via a filler for heat dissipation in a case where the inner surface of the insertion portion is in indirect contact with the main side surface.

10. The circuit integrated motor according to claim 2,
wherein an inner surface of the insertion portion and the main side surfaces are in contact with each other via a filler for heat dissipation in a case where the inner surface of the insertion portion is in indirect contact with the main side surface.
